(19) United States
(12) Patent Application Publication
(10) Pub. No.: US 2025/0349078 A1
(43) Pub. Date: Nov. 13, 2025

(54) INFORMATION PROCESSING APPARATUS, INFORMATION PROCESSING METHOD, AND PROGRAM

(71) Applicant: NTT, Inc., Tokyo (JP)

(72) Inventors: Dai ANDO, Musashino-shi, Tokyo (JP); Takashi SANO, Musashino-shi, Tokyo (JP); Shunichi SEKO, Musashino-shi, Tokyo (JP)

(21) Appl. No.: 18/864,801

(22) PCT Filed: May 19, 2022
(86) PCT No.: PCT/JP2022/020847

§ 371 Date: Nov. 11, 2024

(51) Int. Cl. G06T 19/00; H04N 21/81

(52) U.S. Cl. CPC G06T 19/00; H04N 21/816

(57) ABSTRACT

An information processing device includes a communication unit, a point group data management unit, a sound information analysis unit, an attribute change unit, and a virtual space construction unit. The communication unit communicates with a real world information acquisition device including an environmental sensor and an acoustic sensor. The point group data management unit stores 3D point group data of a real space acquired from the real world information acquisition device. The sound information analysis unit analyzes sound information data to obtain a type of the sound information data. The attribute change unit changes attribute information of the 3D point group data stored in the point group data management unit on the basis of the type of the sound information data. The virtual space construction unit constructs a virtual space video on the basis of the 3D point group data in which the attribute information is changed.

### CROSS-REFERENCE TO RELATED APPLICATIONS

This application is a National Stage application under 35 U.S.C. § 371 of International Application No. PCT/JP2022/020847, having an International Filing Date of May 19, 2022. The disclosure of the prior application is considered part of the disclosure of this application, and is incorporated by reference in its entirety into this application.

### TECHNICAL FIELD

Aspects of this invention relate to an information processing device, an information processing method, and a program, which are used in a virtual space construction technology called XR (virtual reality (VR), augmented reality (AR), mixed reality (MR), and the like).

### BACKGROUND ART

A technique for creating a virtual space using a computer is attracting attention. For example, a virtual space is constructed on a computer server, into which a plurality of persons can log, using a computer graphics (CG) technique or the like. Virtual reality (VR) is a typical technology therefor and is applied, for example, to express a virtual world such as a scene of a quest game. In addition to this, in recent years, attempts have been made to faithfully reproduce the real space (real world) in a 3D virtual space on the basis of measurement data of the real space.

3D point group data obtained by measuring the real space is suitable for expressing the real space in the virtual space. Further, it is conceivable to reflect sound information of the real space in the virtual space. For example, by simultaneously measuring the 3D point group data and the sound information and reflecting the sound information in the virtual space constructed using the 3D point group data, a realistic digital twin can be created.

As a method for reflecting sound information in a virtual space, a method for acoustically reproducing collected sound information on a virtual space side is first conceivable. However, when a person on a virtual space side is hard of hearing or a problem occurs in a device for reproducing sound, it is difficult to recognize sound information on the virtual space side. Thus, a method for visualizing sound information using some means and visually superimposing the sound information on a virtual space side has been studied. For visualizing sound information, for example, NPL 1 and NPL 2 are known.

NPL 1 is an example of visualizing sound effects for an online game. In the online game, sound effect data and visualization data (CG) in the case of visualizing the sound effect data are stored in advance on a game server. In the technique of NPL 1, if a sound effect visualizing function is turned on, visualization data representing the corresponding sound effects is superimposed on game world data (CG) and transmitted to a user terminal. The technique is such that the user terminal displays data received from the game server on a monitor.

NPL 2 is an example of converting speech into text. This device recognizes human voice (speech) input through a microphone, converts it into text information, and displays the converted text as text on a terminal monitor.

### CITATION LIST

### Non Patent Literature

[NPL 1] “[Visualizing Sound Effects] Content Enhanced with Update (Fortnite),” [online], [retrieved May 2, 2022], Internet, <URL:https://hebi-pan.com/fn-visual/>

[NPL 2] “Pocketalk (registered trademark) mimi (SOURCENEXT),” [online], [searched on May 2, 2022], Internet, <URL:https://pocketalkmimi.jp>

### SUMMARY OF INVENTION

### Technical Problem

In a technique for visualizing sound effects in an online game as disclosed in NPL 1, at best, it is possible to visualize sound effect data prepared beforehand, and it is difficult to visualize sound information acquired from a real space in a timely manner in real time. This is because the sound effects and visualization data are simply prepared in advance along with a program of the game and then loaded into a memory and reused. Moreover, since visual data of the game is an object prepared in advance by CG, it is even more difficult to visualize and superimpose the sound information on 3D point group data, which is “a collection of points.”

In a speech-to-text conversion technique as disclosed in NPL 2, in the first place, it is impossible to visualize artificial sound such as car horns, natural sound such as wind sound and rain sound, or surrounding sound (environmental sound). This technique recognizes human speech (conversation speech) and converts it into text to improve communication for people who are hard of hearing, for example, and thus it is not intended to visualize environmental sound and the like in a virtual space.

This invention has been made in view of the above circumstances, and an object thereof is to provide a technique that can reflect sound of a real space in a virtual space.

### Solution to Problem

An information processing device according to one aspect of this invention includes a communication unit, a point group data management unit, a sound information analysis unit, an attribute change unit, and a virtual space construction unit. The communication unit communicates with a real world information acquisition device including an environmental sensor and an acoustic sensor. The point group data management unit stores 3D point group data of a real space acquired from the real world information acquisition device. The sound information analysis unit analyzes sound information data of ambient sound acquired from the real world information acquisition device to obtain a type of the sound information data. The attribute change unit changes attribute information of the 3D point group data stored in the point group data management unit on the basis of the type of the sound information data. The virtual space construction unit constructs a virtual space video on the basis of the 3D point group data in which the attribute information is changed.

### Advantageous Effects of Invention

According to one aspect of this invention, it is possible to provide a technique that can reflect sound of a real space in a virtual space.

### BRIEF DESCRIPTION OF DRAWINGS

FIG. 1 is a diagram showing an example of a system to which an information processing device according to an embodiment is applied.

FIG. 2 is a functional block diagram showing an example of a virtual space management server 1, a real world information acquisition device 2, and a user terminal 3.

FIG. 3 is a diagram showing a flow of data related to the virtual space management server 1, the real world information acquisition device 2, and the user terminal 3.

FIG. 4 is a diagram showing a flow of data related to the virtual space management server 1, the real world information acquisition device 2, and the user terminal 3.

FIG. 5 is a flowchart showing an example of a processing procedure of a processor 70 of the virtual space management server 1.

### DESCRIPTION OF EMBODIMENTS

An embodiment according to this invention will be described below with reference to the drawings. As an introduction, first, 3D point group data will be described.

One of methods for measuring the real space and constructing a virtual space simulating the real space is a method using 3D point group data. The 3D point group data can be acquired using, for example, a light detection and ranging (LiDAR). A LiDAR is a device that measures a distance to, and a direction, a position, a shape, and the like of an object by radiating a laser beam to the object and measuring its round trip time. Scanning results of the laser beam are expressed with points and the collected innumerable points (point group) are stippled, so that an image of the object in the real space can be generated.

Incidentally, in general, the 3D point group data is “just a collection of points” that has attribute information such as three-dimensional coordinate values (X, Y, and Z) and color information (R, G, and B), and it is difficult to superimpose visualized information on the data having such a nature. That is, it is difficult to superimpose sound information data on the 3D point group data. A technique that can solve such a difficulty will be described below.

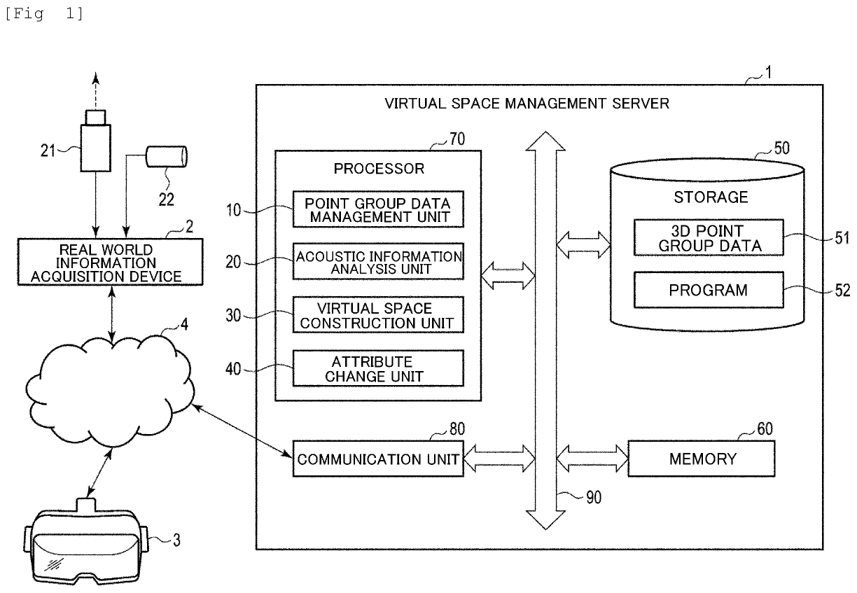

FIG. 1 is a diagram showing an example of a system to which an information processing device according to an embodiment is applied. This system includes, as a core device, a virtual space management server 1 serving as an information processing device. The virtual space management server 1 can access a real world information acquisition device 2 via a network 4, and a user terminal 3 can access the virtual space management server 1 via the network 4.

In FIG. 1, the real world information acquisition device 2 is installed, for example, at an intersection, a park, or the like and acquires environmental information around the installation location. In the embodiment, the 3D point group data and the sound information data are assumed as the environmental information. The real world information acquisition device 2 includes a measurement unit 21 serving as an environmental sensor, and an ambient sound collection unit 22 serving as an acoustic sensor. The measurement unit 21 acquires the 3D point group data of the real space. The ambient sound collection unit 22 acquires the sound information data of the real space. The 3D point group data and the sound information data are transmitted to the virtual space management server 1 via the network 4.

The virtual space management server 1 acquires the 3D point group data and the sound information data via the network 4 and constructs a virtual space video from this data. The user terminal 3 accesses the virtual space management server 1 via the network 4 to acquire the virtual space video.

The virtual space management server 1 is an information processing device (a computer) including a processor 70 and a memory 60. In addition, the virtual space management server 1 includes a storage 50 and a communication unit 80 that functions as a communication interface with the network 4.

The communication unit 80 communicates with the real world information acquisition device 2 via the network 4 to acquire the 3D point group data and the sound information data. The acquired 3D point group data (reference numeral 51) is stored in the storage 50.

The storage 50 further stores a program 52. The program 52 is loaded into the memory 60 by an operation system (OS) of the virtual space management server 1 and executed by the processor 70. The program 52 causes the processor 70 to function as a point group data management unit 10, a sound information analysis unit 20, a virtual space construction unit 30, and an attribute change unit 40.

The point group data management unit 10 stores the 3D point group data of the real space acquired from the real world information acquisition device 2 in the storage 50, for example.

The sound information analysis unit 20 analyzes sound information data of ambient sound acquired from the real world information acquisition device 2 and obtains a type of the sound information data.

The attribute change unit 40 changes the attribute information of the 3D point group data stored in the point group data management unit 10 on the basis of the type of the sound information data.

The virtual space construction unit 30 constructs the virtual space video on the basis of the 3D point group data in which the attribute information is changed.

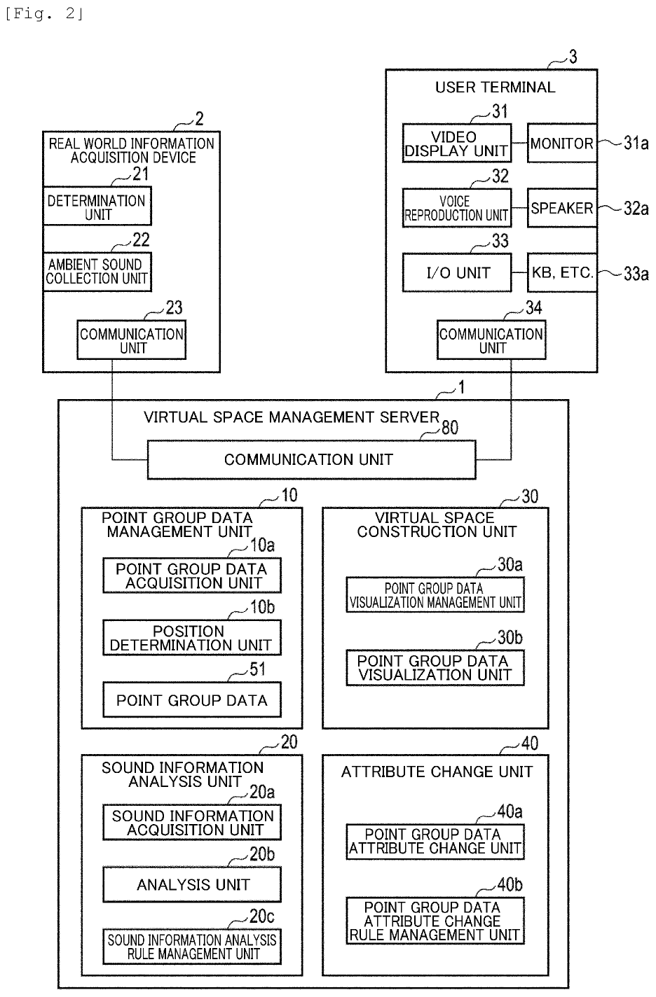

FIG. 2 is a functional block diagram showing an example of the virtual space management server 1, the real world information acquisition device 2, and the user terminal 3. In FIG. 2, the measurement unit 21 of the real world information acquisition device 2 is, for example, LiDAR and scans the real space with a laser beam to obtain the 3D point group data.

The ambient sound collection unit 22 is, for example, a 360-degree microphone and collects sound around the location at which the real world information acquisition device 2 is installed to generate the sound information data. The 3D point group data and the sound information data are transmitted to the virtual space management server 1 via a communication link formed between a communication unit 23 of the real world information acquisition device 2 and the communication unit 80 of the virtual space management server 1.

The user terminal 3 includes a video display unit 31 connected to a monitor 31a, a voice reproduction unit 32 connected to a speaker 32a, an I/O unit 33 connected to a keyboard (KB) 33a or the like, and a communication unit 34. The video display unit 31 displays the virtual space video based on the 3D point group data received from the virtual space management server 1 on the monitor 31a. The voice reproduction unit 32 reproduces sound through the speaker 32a. The I/O unit 33 receives input and output operations of a user from the KB 33a.

The virtual space management server 1 includes the communication unit 80, the point group data management unit 10, the sound information analysis unit 20, the virtual space construction unit 30, and the attribute change unit 40. The point group data management unit 10 includes a point group data acquisition unit 10a and a position determination unit 10b.

The point group data acquisition unit 10a acquires the 3D point group data from the measurement unit 21 of the real world information acquisition device 2 and stores it in the storage 50 as the 3D point group data 51.

The position determination unit 10b acquires the installation position of the real world information acquisition device 2.

The sound information analysis unit 20 includes a sound information acquisition unit 20a, an analysis unit 20b, and a sound information analysis rule management unit 20c. The sound information acquisition unit 20a acquires the sound information data from the ambient sound collection unit 22. The sound information analysis rule management unit 20c manages analysis rules for the sound information data. The analysis unit 20b analyzes the acquired sound information data on the basis of the analysis rules of the sound information analysis rule management unit 20c and calculates the type of the sound information data.

The attribute change unit 40 includes a point group data attribute change unit 40a and a point group data attribute change rule management unit 40b.

The point group data attribute change rule management unit 40b manages change rules of attributes of the 3D point group data. The point group data attribute change unit 40a changes the attribute information of the 3D point group data stored in the point group data management unit 10 on the basis of the change rules of the point group data attribute change rule management unit 40b.

The virtual space construction unit 30 includes a point group data visualization management unit 30a and a point group data visualization unit 30b.

The point group data visualization unit 30b visualizes the 3D point group data in which the attribute information is changed and generates video data of the virtual space.

The point group data visualization management unit 30a manages visualization of the 3D point group data performed by the point group data visualization unit 30b on the basis of the installation position of the real world information acquisition device 2.

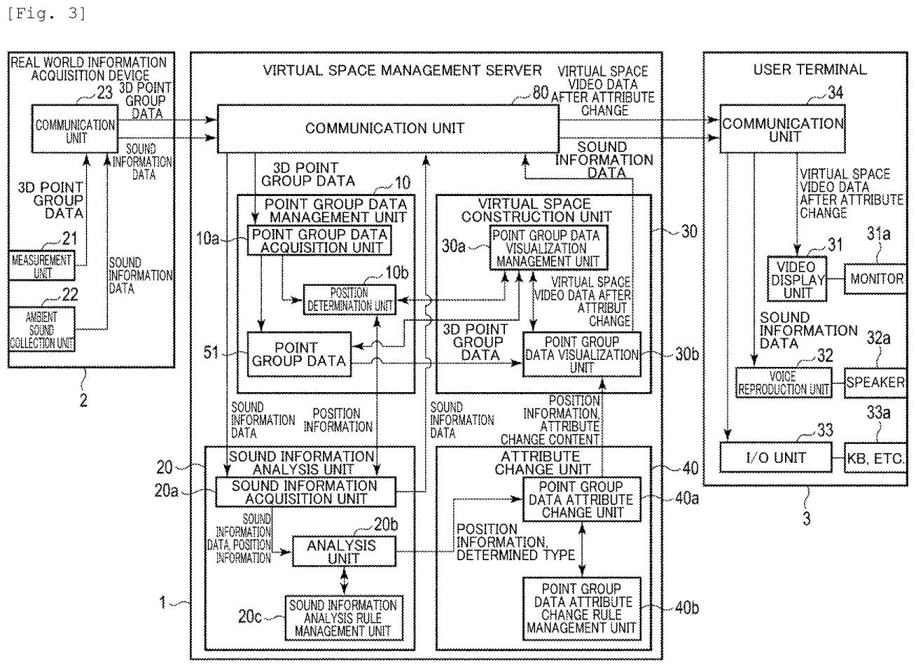

FIG. 3 is a diagram showing a flow of data related to the virtual space management server 1, the real world information acquisition device 2, and the user terminal 3.

In FIG. 3, the real world information acquisition device 2 transmits the 3D point group data around the device acquired by the measurement unit 21 and the sound information data around the device collected by the ambient sound collection unit 22 from the communication unit 23 to the virtual space management server 1.

The virtual space management server 1 transmits the received 3D point group data to the point group data management unit 10 and manages it. The position determination unit 10b of the point group data management unit 10 extracts position information of the real world information acquisition device 2 from the 3D point group data and transfers it to the sound information analysis unit 20.

The sound information acquisition unit 20a of the sound information analysis unit 20 acquires the sound information data and the position information and transfers them to the analysis unit 20b. The analysis unit 20b analyzes the sound information data on the basis of the analysis rules of the sound information analysis rule management unit 20c and determines the type of the sound information data. In particular, the analysis unit 20b determines the type of the sound information data in association with the position information. That is, the type of the sound information data is determined for each position information, and the result is transferred to the attribute change unit 40.

The point group data attribute change unit 40a of the attribute change unit 40 changes the attribute information of the 3D point group data in accordance with the type of the sound information data notified from the analysis unit 20b. In this case, the change rules of the point group data attribute change rule management unit 40b is referred to. The changed content of the attribute information for the 3D point group data is notified to the virtual space construction unit 30 together with the position information.

The point group data visualization unit 30b of the virtual space construction unit 30 superimposes the 3D point group data whose attributes have been changed by the attribute change unit 40 on the original 3D point group data (whose attributes have not been changed) to construct the virtual space video. The construction of the virtual space video is managed by the point group data visualization management unit 30a on the basis of the installation position of the real world information acquisition device 2. The virtual space video after the attribute change is transmitted from the communication unit 80 to the user terminal 3.

The user terminal 3 functions on the basis of an instruction or the like from the user given through the I/O unit 33 and displays the virtual space video after the attribute change received by the communication unit 34 on the monitor 31a. The voice reproduction unit 32 reproduces the sound information.

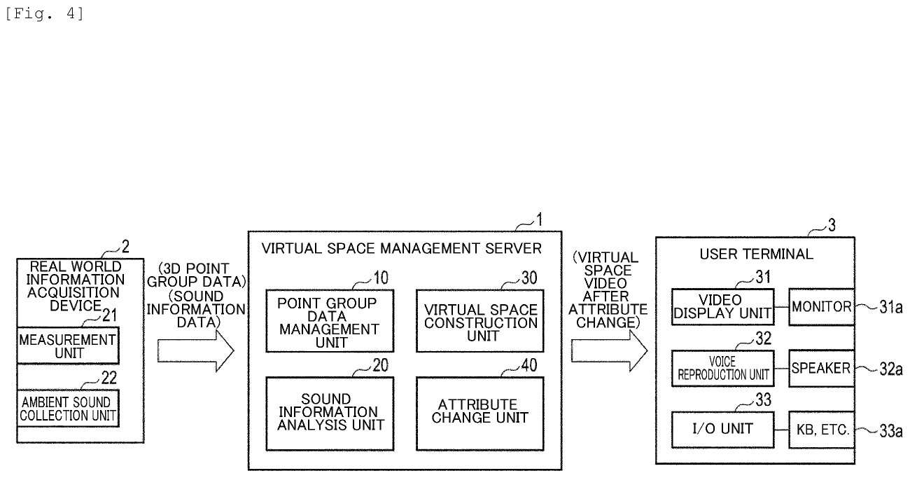

FIG. 4 is a diagram showing a flow of data related to the virtual space management server 1, the real world information acquisition device 2, and the user terminal 3. The 3D point group data and the sound information data collected by the real world information acquisition device 2 are transmitted to the virtual space management server 1. The virtual space management server 1 analyzes the type of the sound information data and changes the attributes of the 3D point group data on the basis of the type. The virtual space video created on the basis of the 3D point group data after the attribute change is transmitted to the user terminal 3 and displayed on the monitor 31a.

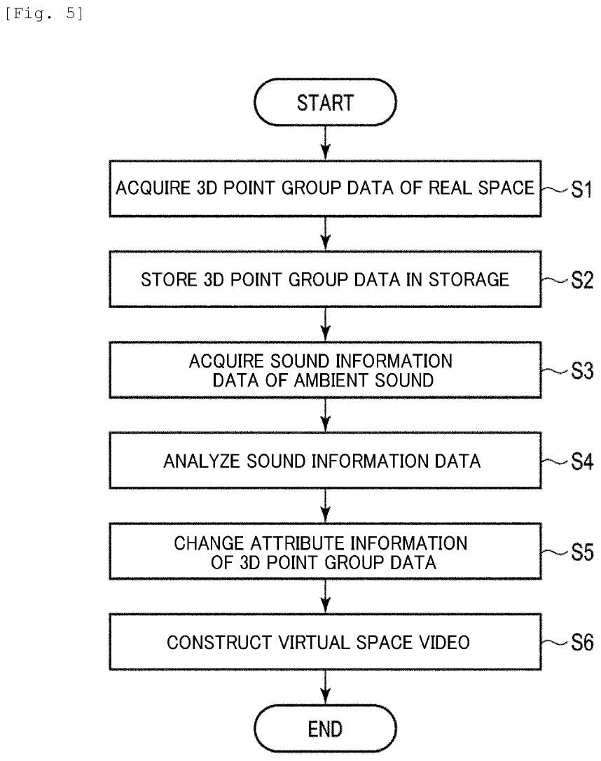

FIG. 5 is a flowchart showing an example of a processing procedure of the processor 70 of the virtual space management server 1. In FIG. 5, the processor 70 acquires the 3D point group data of the real space from the real world information acquisition device 2 (step S1) and stores it in the storage (step S2). In addition, the processor 70 acquires the sound information data of the ambient sound from the real world information acquisition device 2 (step S3), analyzes it, and calculates the type of the sound information data (step S4). Further, the processor 70 changes the attribute information of the 3D point group data on the basis of the type of the sound information data (step S5) and constructs the virtual space video from the 3D point group data in which the attribute information is changed (step S6).

Next, an operation of the above configuration will be described by dividing it into a plurality of operation examples.

### Operation Example 1

In this operation example, the real world information acquisition device 2 is assumed to be installed at an intersection. In this operation example, the virtual space management server 1 analyzes artificial sound of the intersection collected by the real world information acquisition device 2.

### (1) Acquisition of Real Space Information:

First, the real world information acquisition device 2 is installed near an intersection in the real space. The real world information acquisition device 2 senses surroundings using the measurement unit 21 and acquires 3D point group data. The ambient sound collection unit 22 collects sound information around the real world information acquisition device 2. The acquired 3D point group data and the sound information data are transmitted to the virtual space management server 1.

### (2) Storage of Point Group Data:

The virtual space management server 1 stores the 3D point group data received from the real world information acquisition device 2 in the storage 50 and records position information of the intersection serving as a transmission source of the 3D point group data using the position determination unit 10b.

### (3) Analysis of Sound Information:

The virtual space management server 1 analyzes the sound information data around the device received from the real world information acquisition device 2 using the sound information analysis unit 20 together with the position information notified from the position determination unit 10b. The analysis rules used for the analysis are managed by the sound information analysis rule management unit 20c. The analysis rules for <Operation Example 1> are to determine whether or not the sound information is artificial sound such as car horns and the like (rule (a)), and to determine its intensity (rule (b)).

In addition, in the case of <Operation Example 1>, it is assumed that a loud horn sound is generated at the intersection, and it is determined that (a: it is artificial sound) and (b: the sound intensity is large).

### (4) Rules for Changing Attributes of Point Group Data:

The point group data attribute change unit 40a of the virtual space management server 1 changes the attribute data of the 3D point group data on the basis of the position information and the determined type of the sound information. The content (rules) to be changed is defined in the point group data attribute change rule management unit 40b. For example, regarding “artificial sound,” it is assumed that “large” is specified as “red,” “medium” as “orange,” and “small” as “yellow.”

### (5) Change of Attributes of Point Group Data:

In <Operation Example 1>, the sound information data was determined to be (a: it is artificial sound) and (b: the sound intensity is large). In response thereto, the point group data attribute change unit 40a sends [position information and attribute change content] to the virtual space construction unit 30, which indicates the content of changing the attribute information of the color of 3D point group data, for example, within a 3 m range around the coordinates recorded in the position determination unit 10b to numerical values corresponding to “red.”

### (6) Construction of Virtual Space Video After Attribute Change:

The point group data visualization unit 30b of the virtual space construction unit 30 changes attributes of points of the corresponding coordinates among the 3D point group data read from the storage 50 on the basis of the [position information and attribute change content] notified from the point group data attribute change unit 40a. When change of the attributes of all related points is completed, the point group data visualization unit 30b creates virtual space video data using this new point group data. When the virtual space video data is visualized, the area around the intersection at which the real world information acquisition device 2 is installed in the virtual space is displayed with a red point group.

### (7) Display of Virtual Space Video After Attribute Change:

The [virtual space video data after attribute change] in which the area around the intersection in the virtual space at which the real world information acquisition device 2 is installed is displayed with the red point group is transmitted to the user terminal 3. The user terminal 3 receives the data, visualizes it, and displays it on the monitor 31a. In this way, the user can visually recognize in the virtual space that a loud artificial sound has been sounded near the intersection.

### Operation Example 2

In this operation example, the real world information acquisition device 2 is assumed to be installed in a park. In this Operation Example 2, the virtual space management server 1 analyzes natural sound of the park collected by the real world information acquisition device 2.

### (1) Acquisition of Real Space Information:

First, the real world information acquisition device 2 is installed in a park in the real space. The real world information acquisition device 2 senses surroundings using the measurement unit 21 and acquires 3D point group data. The ambient sound collection unit 22 collects sound information around the real world information acquisition device 2. The acquired 3D point group data and the sound information data are transmitted to the virtual space management server 1.

### (2) Storage of Point Group Data:

The virtual space management server 1 stores the 3D point group data received from the real world information acquisition device 2 in the storage 50 and records position information of the park serving as a transmission source of the 3D point group data using the position determination unit 10b.

### (3) Analysis of Sound Information:

The virtual space management server 1 analyzes the sound information data around the device received from the real world information acquisition device 2 together with the position information notified from the position determination unit 10b using the sound information analysis unit 20. The analysis rules used for the analysis are managed by the sound information analysis rule management unit 20c. The analysis rules of <Operation Example 1> are to determine whether or not the sound information is natural sound such as wind sound and the like (rule (a)), and to determine its intensity (rule (b)).

In addition, in <Operation Example 2>, it is assumed that the wind sound that sounds like a “rustle” is collected in the park, and it is determined that (a: it is natural sound) and (b: the sound intensity is medium).

### (4) Rules for Changing Attributes of Point Group Data:

The point group data attribute change unit 40a of the virtual space management server 1 changes attribute data of the 3D point group data on the basis of the position information and the determined type of the sound information. The content (rules) to be changed is defined in the point group data attribute change rule management unit 40b. For example, regarding “natural sound,” it is assumed to be defined that the position information of the point group data of “5 m surrounding” varies within 10% when “large,” “3 m surrounding” varies within 10% when “medium,” and “1 m surrounding” varies within 10% when “small.”

### (5) Change of Attributes of Point Group Data:

In <Operation Example 2>, the sound information data was determined to be (a: natural sound) and (b: sound intensity: medium). In response thereto, the point group data attribute change unit 40a sends [position information and attribute change content] to the virtual space construction unit 30, which indicates the content of varying the coordinates of 3D point group data, for example, within a 3 m range around the coordinates recorded in the position determination unit 10b to numerical values within 10%.

### (6) Construction of Virtual Space Video After Attribute Change:

The point group data visualization unit 30b of the virtual space construction unit 30 changes attributes of points of the corresponding coordinates among the 3D point group data read from the storage 50 on the basis of the [position information and attribute change content] notified from the point group data attribute change unit 40a. When change of the attributes of all related points is completed, the point group data visualization unit 30b creates virtual space video data using this new point group data. When the virtual space video data is visualized, a point group around a position in the park at which the real world information acquisition device 2 is installed in the virtual space is displayed with a “shaking” feeling.

### (7) Display of Virtual Space Video After Attribute Change:

The [virtual space video data after attribute change] in which the area around the position in the park in the virtual space in which the real world information acquisition device 2 is installed is displayed with a “shaking” feeling is transmitted to the user terminal 3. The user terminal 3 receives the data, visualizes it, and displays it on the monitor 31a. In this way, the user can visually recognize that the “medium natural sound” is heard in the park.)

### Operation Example 3

In this operation example, it is assumed that the sound information analysis unit 20 of the virtual space management server 1 uses, for example, an external artificial intelligence (AI) system having a sound information analysis function.

In Operation Examples 1 and 2, the sound information data was analyzed by the sound information analysis unit 20 of the virtual space management server 1. Instead, it is expected that performance of the sound information analyzing function can be improved by linking with the external AI system or the like. To realize this, for example, the sound information analysis unit 20 is equipped with an interface function with the external AI system, transmits the sound information data to the external AI system, and receives the analysis result including the type of the sound information data.

### Operation Example 4

In this operation example, it is assumed that the virtual space management server 1 further has a text change function and has a function of converting sound information into text. In Operation Examples 1 and 2, the attributes of the point group data were changed by the point group data attribute change unit 40a of the virtual space management server 1. In addition to this, in order to make video expression on a virtual space side richer, for example, the speech-to-text conversion function may be used in conjunction with changing the attributes of the point group data. For example, it is preferable to additionally incorporate the speech-to-text conversion function into the sound information analysis unit 20, send the result of the text conversion (text) to the virtual space construction unit 30, and construct the virtual space video on which text information is superimposed.

### Operation Example 5

In this operation example, it is assumed that the virtual space management server 1 further has a video data adding function and has a function of converting sound information into video data.

In Operation Examples 1 and 2, the attributes of the point group data were changed by the point group data attribute change unit 40a of the virtual space management server 1. In addition to this, in order to make video expression on a virtual space side richer, a computer graphics (CG) image corresponding to the type of the sound information is prepared and stored in the storage 50 or the like. Then, in parallel with the change of the attributes of the 3D point group data, the CG image is read and superimposed on the virtual space video.

In this case, for example, it is preferable to add a sound information CG storage function for storing the CG image corresponding to the sound information to the sound information analysis unit 20, send the CG image corresponding to the type of the sound information data to the virtual space construction unit 30, and construct the virtual space video on which the CG image is superimposed.

### Operation Example 6

In this operation example, it is assumed that the real world information acquisition device 2 is portable and freely movable.

In Operation Example 1, it was assumed that the real world information acquisition device 2 is installed at an intersection. In addition, in Operation Example 2, it was assumed that the real world information acquisition device 2 is installed in a park. In both cases, the real world information acquisition device 2 was installed in a fixed manner.

Incidentally, in recent years, mobile terminals (smart phones and the like) having a simple LiDAR measurement function have been known. Thus, in the future, it may become possible to make the real world information acquisition device 2 portable. In such a case, it is preferable to add a position estimating function to the position determination unit 10b in the virtual space management server 1, estimate a current position of the real world information acquisition device 2, and then record the position.

As described above, in the embodiment, the real world information acquisition device 2 having a 3D point group data measuring function and including a microphone or the like for collecting ambient sound is installed at an intersection or a park as an information acquisition device for the real space.

Also, the virtual space management server 1 analyzes the sound information data received from the real world information acquisition device 2 and determines its type. In accordance with the type of sound information data, the virtual space management server 1 changes the attributes of the received 3D point group data and constructs the virtual space video using the 3D point group data. For example, in a case in which the type of the sound information data is determined to be artificial sound (car horns or the like), color information of the points at the corresponding positions of the 3D point group data is changed to red. In addition, when the type of the sound information data is determined to be natural sound (wind sound or the like), coordinate value information of the points at the corresponding positions is changed within a fixed range.

The generated virtual space video data is transmitted to the user terminal 3. In the user terminal 3, the virtual space video in accordance with the 3D point group data whose attributes have been changed based on the sound information data is displayed. Thus, the user can experience a virtual space in accordance with the 3D point group data on which the sound information of the real space is visually reflected.

According to the embodiment, the user can recognize the ambient sound information as visualized information in the virtual space expressed by the 3D point group. Thus, even in a case in which there is an abnormality in a voice reproduction device in the virtual space or a person on the virtual space side is hard of hearing, it is possible to recognize the ambient sound information of the real space.

For these reasons, according to the embodiment, it is possible to provide a technique that can reflect the sound of the real space in the virtual space.

Also, this invention is not limited to the above-described embodiment as it is.

For example, in <Operation Example 1>, the sound information analysis unit 20 determined whether or not the sound information data was artificial sound. When the performance of sound information analysis is further improved, it is expected that the sound information analysis unit 20 can determine even a type of the artificial sound (whether or not it is a horn sound, a collision sound, or the like). If this becomes possible, it is conceivable to increase change patterns in the point group data attribute change unit 40a, for example, in response to an increase in types of distinguishable artificial sounds.

In addition, in <Operation Example 2>, the sound information analysis unit 20 determined whether or not the sound information data was natural sound. When the performance of sound information analysis is further improved, it is expected that the sound information analysis unit 20 can determine even a type of the natural sound (wind sound, rain sound, or the like). If this becomes possible, it is conceivable to increase change patterns in the point group data attribute change unit 40a, for example, in response to an increase in types of distinguishable natural sounds.

Also, at the implementation stage, the present invention can be embodied by modifying constituent elements within a range not departing from the gist thereof. Further, various inventions can be formed by appropriately combining a plurality of constituent elements disclosed in the above-described embodiment. For example, some constituent elements may be deleted from all constituent elements shown in the embodiment. Furthermore, constituent elements of different embodiments may be combined as appropriate.

### REFERENCE SIGNS LIST

1 Virtual space management server
2 Real world information acquisition device
3 User terminal
4 Network
10 Point group data management unit
10a Point group data acquisition unit
10b Position determination unit
20 Sound information analysis unit
20a Sound information acquisition unit
20b Analysis unit
20c Sound information analysis rule management unit
21 Measurement unit
22 Ambient sound collection unit
23 Communication unit
30 Virtual space construction unit
30a Point group data visualization management unit
30b Point group data visualization unit
31 Video display unit
31a Monitor
32 Voice reproduction unit
32a Speaker
33 I/O unit
33a Keyboard
34 Communication unit
40 Attribute change unit
40a Three-point group data attribute change unit
40b Three-point group data attribute change rule management unit
50 Storage
51 3D point group data
52 Program
60 Memory
70 Processor
80 Communication unit

1. An information processing device comprising:
a communication unit configured to communicate with a real world information acquisition device including an environmental sensor and an acoustic sensor;
a point group data management unit, including one or more processors, configured to store 3D point group data of a real space acquired from the real world information acquisition device;
a sound information analysis unit, including one or more processors, configured to analyze sound information data of ambient sound acquired from the real world information acquisition device to obtain a type of the sound information data;
an attribute change unit, including one or more processors, configured to change attribute information of the 3D point group data stored in the point group data management unit on the basis of the type of the sound information data; and
a virtual space construction unit, including one or more processors, configured to construct a virtual space video on the basis of the 3D point group data in which the attribute information is changed.

2. The information processing device according to claim 1, wherein the point group data management unit includes:
a point group data acquisition unit, including one or more processors, configured to acquire the 3D point group data from the environmental sensor;
a point group data storage unit, including one or more processors, configured to store the acquired 3D point group data; and
a position determination unit, including one or more processors, configured to acquire an installation position of the real world information acquisition device.

3. The information processing device according to claim 1, wherein the sound information analysis unit includes:
a sound information acquisition unit, including one or more processors, configured to acquire the sound information data from the acoustic sensor;
a sound information analysis rule management unit, including one or more processors, configured to manage an analysis rule of the sound information data; and
an analysis unit, including one or more processors, configured to analyze the acquired sound information data on the basis of the analysis rule and calculate the type of the sound information data.

4. The information processing device according to claim 1, wherein the sound information analysis unit comprises an interface function with an AI system having a sound information analysis function, and a function of transmitting the acquired sound information data to the AI system and receiving a result of analysis of the sound information data by the AI system.

5. The information processing device according to claim 1, wherein the attribute change unit includes:
a point group data attribute change rule management unit, including one or more processors, configured to manage a change rule of an attribute of the 3D point group data; and
a point group data attribute change unit, including one or more processors, configured to change the attribute information of the 3D point group data stored in the point group data management unit on the basis of the change rule.

6. The information processing device according to claim 1, wherein the virtual space construction unit includes:
a point group data visualization unit, including one or more processors, configured to visualize the 3D point group data in which the attribute information is changed to generate video data of a virtual space and
a point group data visualization management unit, including one or more processors, configured to manage visualization of the 3D point group data on the basis of an installation position of the real world information acquisition device.

7. An information processing method executed by a processor of an information processing device including the processor and a storage, comprising:
communicating with a real world information acquisition device including an environmental sensor and an acoustic sensor;
storing 3D point group data of a real space acquired from the real world information acquisition device in the storage;
analyzing sound information data of ambient sound acquired from the real world information acquisition device to obtain a type of the sound information data;
changing attribute information of the 3D point group data stored in the storage on the basis of the type of the sound information data; and
constructing a virtual space video on the basis of the 3D point group data in which the attribute information is changed.

8. A program configured to cause a computer to function as each unit of the information processing device according to any one of claims 1.
